(19) United States
(12) Patent Application Publication
(10) Pub. No.: US 2011/0029865 A1
(43) Pub. Date: Feb. 3, 2011

(54) Control Interface For A Medical Monitor

(75) Inventors: Bruce Gilland, Superior, CO (US); Bryan Hansen, Mead, CO (US)

Correspondence Address: NELLCOR PURITAN BENNETT LLC;ATTN: IP LEGAL, 6135 Gunbarrel Avenue, Boulder, CO, 80301, US

(73) Assignee: Nellcor Puritan Bennett LLC, Boulder, CO (US)

(21) Appl. No.: 12/533,246

(22) Filed: Jul. 31, 2009

(51) Int. Cl. G06F 3/01; G06F 3/048

(52) U.S. Cl. 715/702; 715/773

(57) ABSTRACT

The present disclosure describes the use of virtual control structures on medial devices, such as medical monitors. The virtual control structures may be implemented as virtual knobs, virtual sliders, or as other structures suitable for adjusting an operational parameter of the medical or other device. When displayed on a touch screen, the virtual control structures may be manipulated to adjust the operational parameter. When not in use, the virtual control structure may be hidden or minimized, allowing the touch screen to be primarily used for the display of patient data or operational data for the device.

### BACKGROUND

The present disclosure relates generally to medical devices and, more particularly, to monitors used for monitoring physiological parameters of a patient.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the field of medicine, doctors often desire to monitor certain physiological characteristics of their patients. Accordingly, a wide variety of devices have been developed for monitoring many such physiological characteristics. Such devices provide doctors and other healthcare personnel with the information they need to provide the best possible healthcare for their patients. As a result such monitoring devices have become an indispensable part of modern medicine.

A monitoring system may include a sensor, lead or other device that allows the collection of data that may be processed to derive one or more physiological characteristics of a patient. For example, such sensors may include pulse oximetry sensors or probes that may be applied to a patient and which generate data related to the light absorption and/or transmission in the tissue. Such data may be used to measure blood oxygen saturation or other characteristics related to the patients blood, blood constituents, and/or circulation. Similarly, other types of sensors may be applied to a patient and may return data related to electrical activity of the heart, brain, or muscles, temperature, hydration or tissue water fraction, blood pressure, carbon dioxide levels, blood sugar levels, and so forth.

Such sensing devices may provide an interface for collecting data from the patient. The sensing devices may in turn communicate with a corresponding monitoring device on which the collected data may be processed and/or some physiological characteristic derived from the data may be displayed for review by a caregiver. In addition, a monitoring device may provide alarms or other functions whereby the monitored physiological characteristic may provide automated responses from the device under specific conditions. Thus, a monitoring device may sound or display an alarm in the event that a monitored physiological characteristic is outside an expected bound.

In the course of operation, it may be desirable to adjust the operation of such a monitoring device, such as to adjust alarm levels, adjust a volume control or a brightness or contrast control, adjust operation of an algorithm executing on the monitor, or to switch between modes of operation or display options for the monitor. However, in the limited space provided on a control interface of a monitoring device, it may be difficult to provide suitable controls to control operation of all of the parameters that may be adjusted. Further, as newer versions of monitoring devices are released with new interfaces, users trained on previous versions of a monitoring device may be unfamiliar or uncomfortable with new and different control schemes.

### BRIEF DESCRIPTION OF THE DRAWINGS

Advantages of the disclosed techniques may become apparent upon reading the following detailed description and upon reference to the drawings in which:

FIG. 1 is a view of a multiparameter monitor and exemplary patient monitor in accordance with aspects of an embodiment;

FIG. 2 illustrates a simplified block diagram of a pulse oximeter in FIG. 1, according to an embodiment;

FIG. 3 illustrates a view of a control interface of a monitor in accordance with an embodiment;

FIG. 4 illustrates a view of a control interface including a virtual knob control structure in accordance with an embodiment;

FIG. 5 illustrates a view of a control interface including a virtual slider control structure in accordance with an embodiment;

FIG. 6 illustrates a view of a control interface without a control for invoking a virtual control structure in accordance with an embodiment;

FIG. 7 illustrates a view of a control interface including options that may be selected for adjustment in accordance with an embodiment;

FIG. 8 illustrates a view of a control interface including a displayed value undergoing adjustment in accordance with an embodiment;

FIG. 9 illustrates a view of a control interface including a virtual knob being manipulated in accordance with an embodiment;

FIG. 10 illustrates a view of a control interface including a virtual knob after being manipulated in accordance with an embodiment;

FIG. 11 illustrates a view of a control interface including a virtual knob being manipulated in accordance with an embodiment;

FIG. 12 illustrates a view of a control interface including a virtual knob being manipulated in accordance with an embodiment; and

FIG. 13 illustrates a view of a control interface including a virtual knob having multiple inner rings in accordance with an embodiment.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to control interfaces for monitoring devices, such as pulse oximeters. In one embodiment, a control interface may be a touch-sensitive display, i.e., a touch screen, that allows a user to control or adjust one or more operations of the monitoring device by touching the screen. In one embodiment, the touch sensitive display may display a graphical representation of a control structure that corresponds to a mechanical control structure, such as a knob, dial, slider, and so forth. By interacting with the graphical representation of the control structure, a user may adjust one or more operating parameters of the monitoring device. Further, due to control structure being a graphical representation ( as opposed to a physical construct), in one embodiment, the graphical representation of the control structure may be reduced or hidden from view when not in use and displayed only as needed to receive user adjustments. With this in mind, a system suitable for use of a monitor utilizing graphical control elements will be initially described.

To facilitate explanation of the concepts described herein, a monitoring device may be discussed with respect to a particular use or context, such as pulse oximetry. While such an example may be useful for providing context when explaining certain features of a control interface, it should be understood that such examples are provided merely provided for explanatory purposes and are not intended to be limiting in any way. Indeed, the concepts discussed herein with respect to control of a device may be applied in a wide variety of medical and non-medical devices and, within field of medicine, may be applied to a wide range of patient monitoring and patient care technologies.

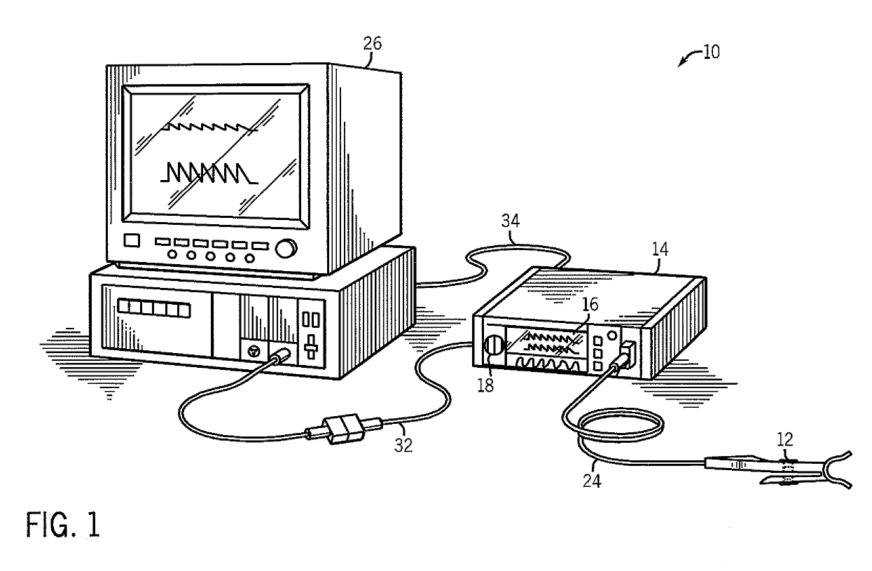

With this in mind, FIG. 1 provides a perspective view of a pulse oximetry system 10 in accordance with embodiments of the present disclosure. The system 10 includes a sensor 12 and a pulse oximetry monitor 14. The sensor 12 may emit light at certain wavelengths into a patient's tissue and may detect the light after it is transmitted or scattered through the patient's tissue. The monitor 14 may be capable of calculating physiological characteristics based on the signals received from the sensor 12 relating to light emission and detection. Further, the monitor 14 includes a touch screen 16, such as a color touch screen, capable of displaying the physiological characteristics, historical trends of the physiological characteristics, other information about the system, and/or alarm indications. The monitor 14 may include a speaker 18 to provide an audible alarm in the event that the patient's physiological characteristics cross an alarm threshold. The sensor 12 may be communicatively coupled to the monitor 14 via a cable 24. However, in other embodiments a wireless transmission device or the like may be utilized instead of or in addition to the cable 24.

In the illustrated embodiment, the pulse oximetry system 10 also includes a multi-parameter patient monitor 26. In addition to the monitor 14, or alternatively, the multi-parameter patient monitor 26 may be capable of calculating physiological characteristics and providing a central display for information from the monitor 14 and from other medical monitoring devices or systems. For example, the multi-parameter patient monitor 26 may display a patient's SpO₂ and pulse rate information from the monitor 14 and blood pressure from a blood pressure monitor. Additionally, the multi-parameter patient monitor 26 may indicate an alarm condition via the display and/or a speaker if the patient's physiological characteristics are found to be outside of the expected range. The monitor 14 may be communicatively coupled to the multi-parameter patient monitor 26 via a cable 32 or 34 coupled to a sensor input port or a digital communications port, respectively. In addition, the monitor 14 and/or the multi-parameter patient monitor 26 may be connected to a network to enable the sharing of information with servers or other workstations.

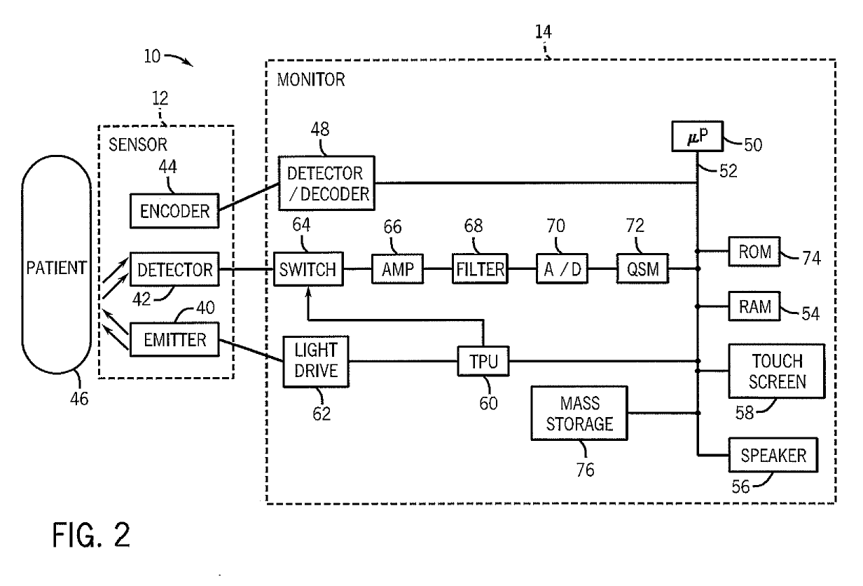

Turning to FIG. 2, a simplified block diagram of the system 10 is illustrated in accordance with one embodiment. Specifically, certain components of the sensor 12 and the monitor 14 are illustrated in FIG. 2. In one embodiment, the sensor 12 may include an emitter 40, a detector 42, and an encoder 44. It should be noted that the emitter 40 may be capable of emitting more than one wavelengths of light, such as red (e.g., about 600 nanometers (nm) to about 700 nm) and infrared (IR) light (e.g., about 800 nm to about 1000 nm), into the tissue of a patient 46. The emitter 40 may include a single light emitting component or multiple light emitting components (e.g., one or more LEDs). Light from the emitter 40 may be used to measure, for example, blood oxygen levels, water fractions, hematocrit, or other physiological parameters of the patient 46. It should be understood that, as used herein, the term “light” may refer to one or more of radio, microwave, millimeter wave, infrared, visible, ultraviolet, gamma ray or X-ray electromagnetic radiation, and may also include any wavelength within the radio, microwave, infrared, visible, ultraviolet, or X-ray spectra, and that any suitable wavelength of light may be appropriate for use with the present disclosure.

In one embodiment, the detector 42 may be one or an array of detector elements that may be capable of detecting light at various intensities and wavelengths. In one embodiment, light enters the detector 42 after passing through the tissue of the patient 46. The detector 42 may generate an electrical signal based on the intensity of light incident upon the detector 42, which may be directly related to the absorbance and/or reflectance of light in the tissue of the patient 46. That is, when more light at a certain wavelength is absorbed, less light of that wavelength is typically incident on the detector 42, and when more light at a certain wavelength is reflected, more light of that wavelength is typically incident on the detector 42. The detector 42 may send the electrical signal generated at the detector 42 to the monitor 14, where physiological characteristics may be calculated based at least in part on the absorption and/or reflection of light by the tissue of the patient 46.

Additionally the sensor 12 may include an encoder 44, which may contain information about the sensor 12 or about components (e.g., the emitter 40 and the detector 42) of the sensor 12, such as what type of sensor it is (e.g., whether the sensor is a reflectance sensor, a transmittance sensor, etc., where the sensor is emitting and detecting light, and so forth) and the wavelengths of light emitted by the emitter 40. This information may allow the monitor 14 to select appropriate algorithms and/or calibration coefficients for calculating the patient's physiological characteristics. The encoder 44 may, for instance, be a memory on which one or more of the following information may be stored for communication to the monitor 14: the type of the sensor 12; the wavelengths of light emitted by the emitter 40; and the proper calibration coefficients and/or algorithms to be used for calculating the patient's 46 physiological characteristics. In one embodiment, the data or signal from the encoder 44 may be decoded by a detector/decoder 48 in the monitor 14.

Signals from the detector 42 and the encoder 44 may be transmitted to the monitor 14. The monitor 14 may include data processing circuitry (such as one or more processors 50, application specific integrated circuits (ASICS), or so forth) coupled to an internal bus 52. Also connected to the bus may be a RAM memory 54, a speaker 56, and a touch screen display 58, such as a color, black and white, or grayscale touch screen display. A time processing unit (TPU) 60 may provide timing control signals to light drive circuitry 62, which controls when the emitter 40 of the sensor 12 is activated, and if multiple light sources are used, the multiplexed timing for the different light sources. TPU 60 may also control the gating-in of signals from detector 42 through a switching circuit 64. These signals are sampled at the proper time, depending at least in part upon which of multiple light sources is activated, if multiple light sources are used. The received signal from the detector 42 may be passed through an amplifier 66, a low pass filter 68, and an analog-to-digital converter 70 for amplifying, filtering, and digitizing the electrical signals the from the sensor 12. The digital data may then be stored in a queued serial module (QSM) 72, for later downloading to RAM 54 as QSM 72 fills up. In one embodiment, there may be multiple parallel paths for separate amplifiers, filters, and A/D converters for multiple light wavelengths or spectra received.

The data processing circuitry (such as processor 50) may derive one or more physiological characteristics based on data provided by the sensor 12. For example, in the depicted pulse oximetry context, based at least in part upon the received signals corresponding to the light received by detector 42, processor 50 may calculate an oxygen saturation value using various algorithms. These algorithms may use coefficients, which may be empirically determined. For example, algorithms relating to the distance between an emitter 40 and various detector elements in a detector 42 may be stored in a ROM 74 or mass storage device 76 (such as a magnetic or solid state hard drive or memory or an optical disk or memory) and accessed and operated according to processor 50 instructions. Once calculated, the physiological characteristic (such as oxygen saturation, pulse rate, respiratory rate, respiratory effort, blood pressure, and so forth) may be displayed on the touch screen 58 for a caregiver to monitor or review.

In addition, data processing circuitry (such as the processor 50 or a separate processor or ASIC) may cause the display of various graphical elements on the touch screen 58, such as the graphical control structures discussed herein. In one embodiment, algorithms for implementing such graphical control structures may be coded in a suitable language, such as an object oriented language (e.g., visual C++), and stored in the ROM 74 and/or mass storage device 76. In addition, user or other preferences related to the display of graphical elements and/or control structures may also be stored in the ROM 74 and/or mass storage device 76. The coded algorithms and/or preferences for implementing graphical elements and/or control structures may be loaded into the RAM 54 as needed and executed by the processor 50 or another processor to cause the display of particular graphical elements and/or control structures on the touch screen 58. Likewise user inputs received in response to the display of graphical elements and/or control structures on the touch screen 58 may be provided back to the processor as a user input for controlling or adjusting operation of the monitor 14.

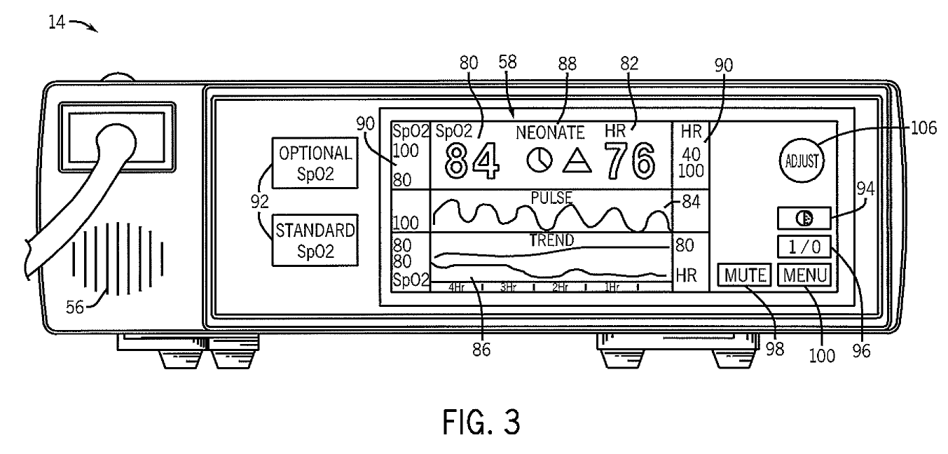

With the foregoing in mind and turning to FIG. 3, one embodiment of a monitor 14 displaying physiological characteristics is depicted. In this embodiment, the monitor 14 includes a touch screen 58, such as a color touch screen, on which the physiological characteristics are displayed. The displayed physiological characteristics may include, by way of example, blood oxygen saturation 80 at the measurement site (e.g., SpO2), heart rate 82, a plethysmographic waveforms 84, historical or trend data 86, and so forth.

In addition, the touch screen 58 may display indications related to the operation of the monitor 14, such as an indication 88 that the monitor 14 is operating in a neonatal or adult mode or indications 90 of the current alarm limits or expected values for a physiological characteristic. The touch screen 58 may also display one or more touch sensitive controls for adjusting operation of some aspect of the monitor 14, such as operational controls 92 for determining the manner in which a physiological characteristic is calculated, display controls 94 for adjusting screen brightness and/or contrast, power controls 96 for turning the monitor 14 on or off, audio controls 98 to adjust the volume or to mute the audio output of the monitor 14, and/or menu controls 100 to invoke the display of other monitor options or functions.

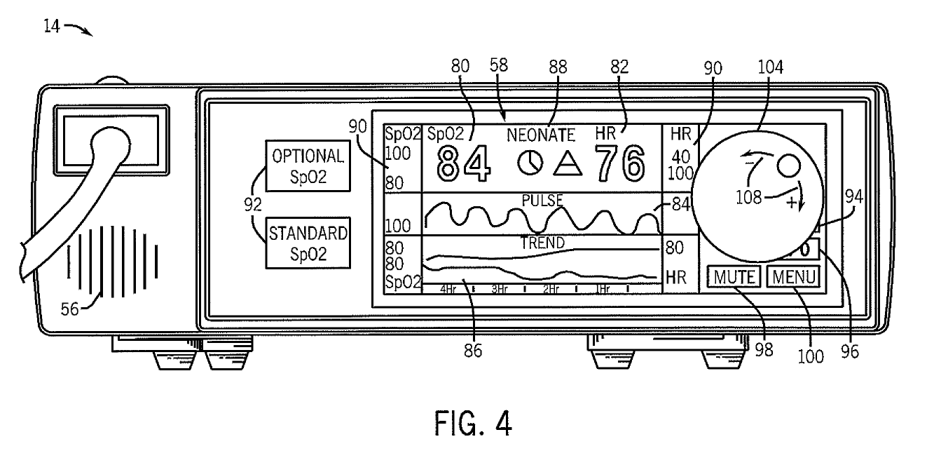

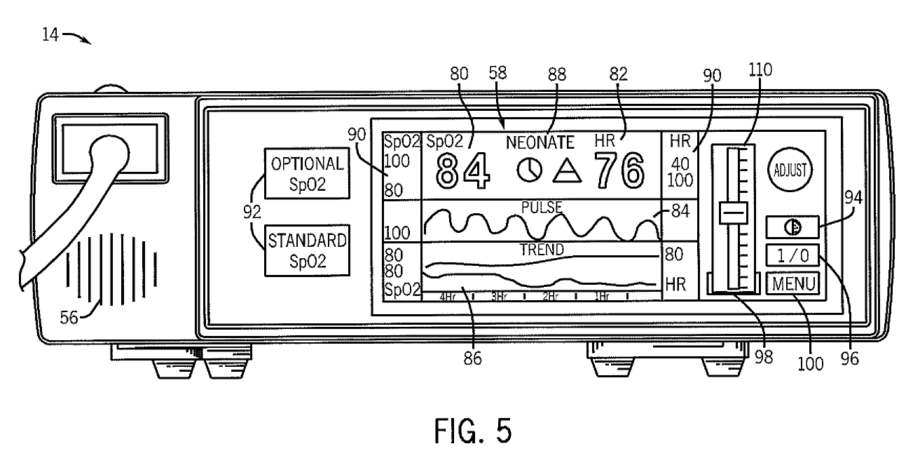

In one embodiment, the touch screen 58 may also display a graphical representation corresponding to or resembling a mechanical or physical control structure, i.e., a virtual control structure. In certain embodiments the virtual control structure may be provided as a virtual knob 104 (FIG. 4) or virtual slider 110 (FIG. 5). For adjusting a setting having a range of potential values, it may be desirable to provide such a graphical control interface that allows the user to rapidly move through the range of potential values to select the desired value. In one embodiment, the virtual control structure may be engaged using a continuous motion (such as sliding or rotating the finger on the touch screen 58 with respect to the virtual control structure) as opposed to discontinuous contacts (such as tapping buttons, numbers, or letters to enter an input). In such instances a virtual knob 104 may be “rotated” or a virtual slider 110 may be “slid” to allow rapid adjustment of an operational parameter of the monitor 14 (such as an alarm value, monitor volume, setting of a timer, and so forth) through a range of possible values.

Returning to FIG. 3, to preserve space on the touch screen 58 for the display of physiological characteristics and other useful information, the virtual control structure may be minimized or hidden from view when not in use. For example, referring to FIG. 3, an invoking control 106 may be provided which invokes the display of the virtual control structure, such as the virtual knob 104 (FIG. 4) or the virtual slider 110 (FIG. 5). In one such embodiment, the displayed control 106 may be touched or tapped once, twice, or more to invoke the display of the virtual control structure on the touch screen 58 and to prepare the monitor 14 to receive inputs via the displayed virtual control structure.

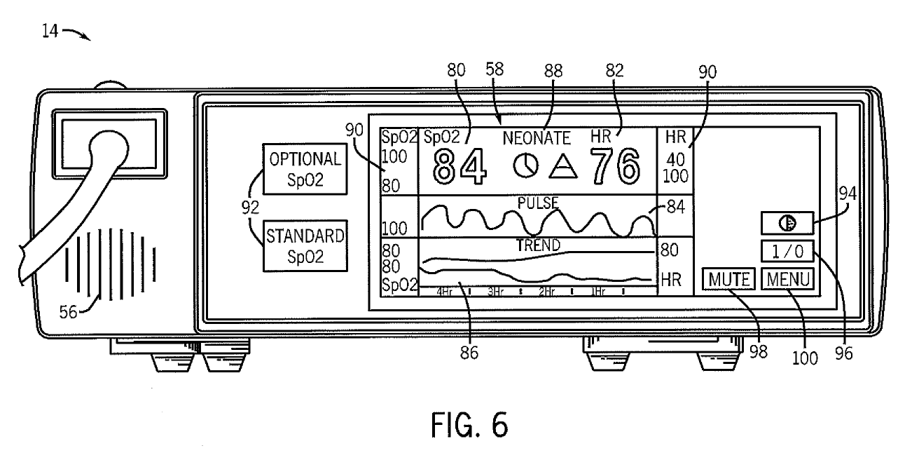

As part of the process of invoking the virtual control structure, the user may specify what operating parameter of the monitor 14 is to be adjusted. For example, to adjust an alarm threshold related to heart rate, the user might touch the displayed heart rate 82 or heart rate alarm limit indications 90 prior to touching the invoking control 106. Alternatively, the order of these acts may be changed such that the invoking control 106 is touched before or in conjunction with the parameter to be adjusted. Further, in one embodiment, no invoking control 106 may be displayed or provided (FIG. 6). Instead, the virtual control structure may be invoked by the user touching or repeatedly touching a displayed indication of the operating parameter (e.g., alarm limits) of the monitor 14 to be adjusted or a related displayed value. For example, in one embodiment a user may invoke a virtual control structure to adjust alarm limits associated with heart rate by touching or repeatedly touching the displayed alarm limit indications 90 associated with heart rate or by touching the displayed heart rate 82 itself, which the monitor 14 may interpret as an intent by the user to adjust a parameter associated with the presentation, reporting or monitoring of the heart rate.

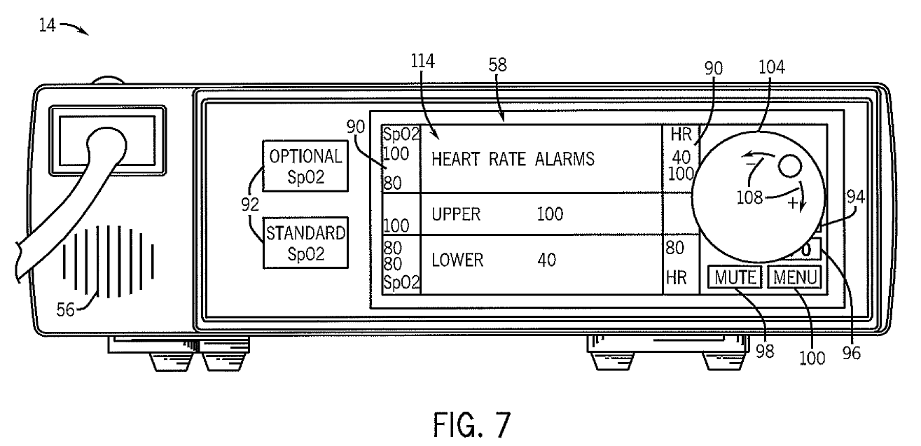

In instances where there may be ambiguity as to the parameter to be adjusted, such as where more than one alarm threshold may be associated with a physiological characteristic, the different options 114 as to the parameter to be adjusted may be displayed, as depicted in FIG. 7. A user may then select the appropriate option 114 by touching the desired option or by otherwise selecting the appropriate selection using an input structure of the monitor 14. Though FIG. 7 depicts the virtual control structure, e.g., virtual knob 104, as being displayed with the available options 114 for adjustment, in other implementations the virtual control structure may be displayed after the parameter to be adjusted has been specified, that is, after selection of an option 114.

In addition, in certain embodiments a user may attempt to select from a number of closely spaced displayed values or indicators on the touch screen 58 when invoking the virtual control structure. Depending on the spacing of the values or indications it may be difficult for the user to make the desired selection and/or it may be difficult for the monitor to recognize the selection due to the close proximity of other viable selections. In one embodiment, the monitor 14 may cycle through the possible intended selections, allowing the user to select the desired parameter to adjust. For example, at the first touch by the user one possible parameter for adjustment may be displayed or highlighted. If the displayed or highlighted parameter is not the parameter the user intends to adjust, the user may continue touching or tapping the touch screen 58 to cycle through the possible parameters for adjustment that may be invoked near the area where the touch is occurring until the desired parameter is displayed. Once the desired parameter is displayed, the user may proceed to adjust the parameter using a displayed virtual control structure.

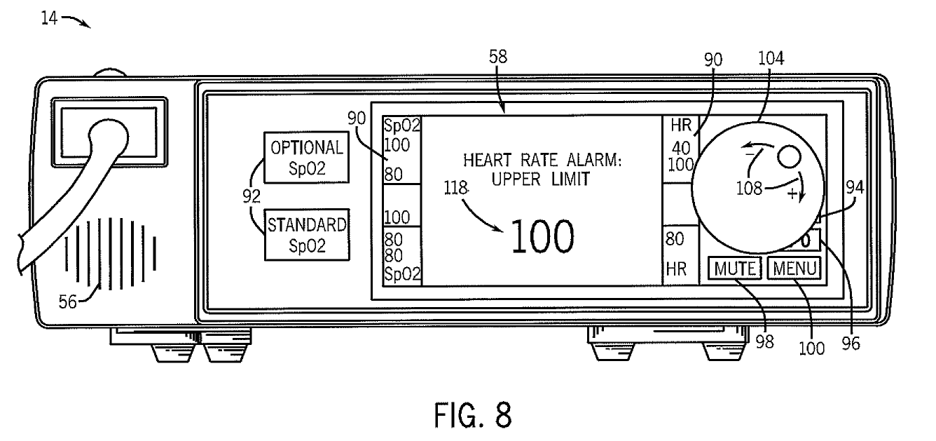

Once the parameter to be modified has been specified, a value 118 of the parameter being adjusted may be displayed on the touch screen 58 in conjunction with the virtual control structure, e.g., virtual knob 104, as depicted in FIG. 8. In one embodiment, the location where the virtual control structure is displayed relative to the displayed value 118 may be configurable, such as to accommodate whether the user is right-handed or left-handed. Such configurability may be based on a user identification or preference known or ascertainable by the monitor 14, such as based on a login or menu configured preference. Alternatively, in one embodiment the user may use a dragging or directional motion on the touch screen 58 to move the virtual control structure from one side of the touch screen 58 to the other, with the displayed value 118 being repositioned on the touch screen 58 as part of the movement process. Further, in one embodiment the manner in which the virtual control structure is invoked may determine on which side of the touch screen 58 the virtual control structure is displayed. In one such embodiment, tapping or touching a displayed invoking control 106 (FIG. 3) or a displayed parameter to be adjusted on the right or left side will cause the virtual control structure to be invoked and displayed on that respective side of the touch screen 58. In such an embodiment, tapping or touching the displayed invoking control 106 or the displayed parameter to be adjusted in an indeterminate location, such as in the center or on the top or bottom, may cause the virtual control structure to be invoked and displayed at a default location, such as on the right hand side of the touch screen 58.

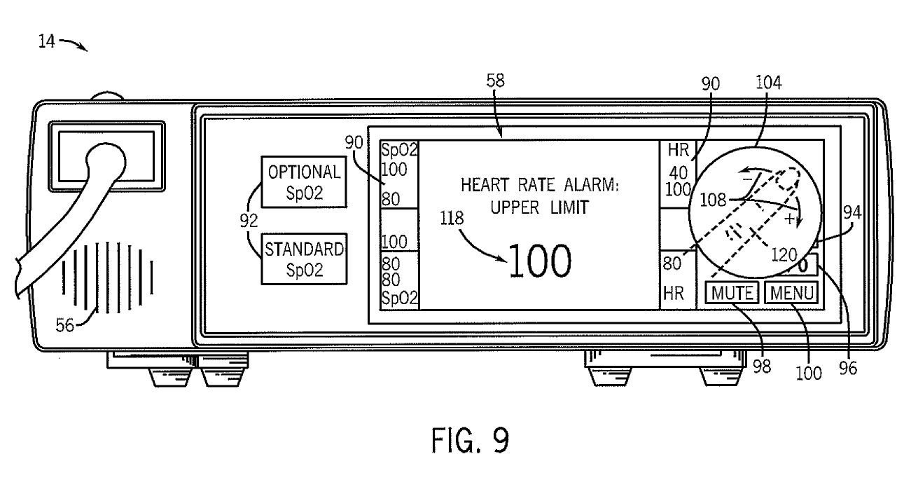

Once the virtual control structure is displayed, a user may interact with the virtual control structure in a manner similar to how the corresponding physical structure is manipulated. For example, with respect to FIG. 9, the user may place a finger 120 on the virtual knob 104 and move the finger in a continuous clockwise or counterclockwise motion (as opposed to discontinuous or sporadic contact), as indicated by directional arrows 108, to simulate turning the virtual knob 104.

In one embodiment an audible and/or visual indication may be provided when the virtual control structure is contacted or touched by a user. In this manner, a user may recognize that the virtual control structure is ready to be manipulated or moved. In such implementations where the virtual control structure is a virtual knob 104, the appearance and/or position of the virtual knob 104 may be adjusted or altered when touched by the user. Thus, the appearance of the virtual knob 104 (e.g., the color, hatching, or texture of the virtual knob 104) may be altered when a user touches the virtual knob 104. Instead of or in addition to such an appearance change, the position of the virtual knob 104 may be adjusted (such as shifted downward and to the right on the touch screen 58) when the user touches the virtual knob, such as to create an impression that the virtual knob 104 has been depressed or otherwise engaged by the user. In such an embodiment, the virtual knob 104 may be displayed so as to appear to be three-dimensional, with the three-dimensional appearance altered to create the appearance that the virtual knob 104 is depressed when touched by the user.

Further, in one embodiment, movement of the virtual control structure may be accompanied by an audible indication of the movement. In one such implementation, rotating or turning a virtual knob 104 may cause the monitor 14 to provide audible feedback, such as clicks, via the speaker 56. In such an embodiment, the audible feedback may correspond to the rate of movement of the control structure. In this way, in an implementation of a virtual knob 104 a click might be generated each time the virtual knob 104 is rotated by a certain degree or each time the value 118 is incremented (positively or negatively) by a certain amount such as by 1, 2, 5, or 10.

The audible feedback may be configurable by a user, such as via one or more setup screens or menus accessible on the monitor 14. In one such embodiment, a user may configure whether audible feedback is provided or not. If audible feedback is to be provided, the user may also configure the volume at which the audible feedback is provided and/or may select a particular sound or tone to be used in providing the audible feedback. Further, if audible feedback is to be provided, the user may configure the rate at which the feedback is to be provided with respect to the movement of the virtual control structure, e.g., the rotation of the virtual knob 104, or to the rate of adjustment of the value 118.

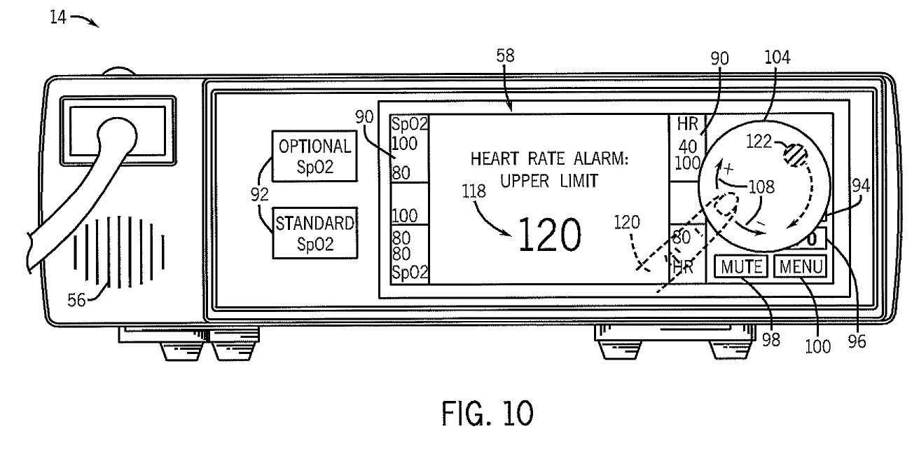

As depicted in FIG. 9, movement of the finger 120 on the virtual knob 104 in a continuous clockwise or counterclockwise motion may simulate turning the virtual knob 104 such that the parameter of interest is adjusted in response to this motion. The adjustment to the operational parameter of interest, here depicted as the upper limit for a heart rate alarm, may correspond to the direction of rotation, the degree or extent of rotation, and/or the speed of rotation. In the context of FIG. 10, for example, the user may move his finger clockwise from initial position 122 to “turn” the knob 104 and increase the alarm limit, as indicated by value 118 (e.g., the depicted alarm limit), or may move his finger counterclockwise to decrease the value 118. The rate at which the value 118 is incremented (positively or negatively) may be based upon the absolute degree or amount of rotation of the virtual knob 104 (i.e., 1° of rotation corresponds to ±1 for value 118) and/or based upon the rate at which the virtual knob 104 is rotated (i.e., 1° of rotation per second corresponds to ±1 for value 118 while 5° of rotation per second corresponds to ±10 for value 118).

In one embodiment the user may configure the sensitivity of the virtual control structure, such as via one or more setup screens or menus accessible on the monitor 14. In one such embodiment, the user may configure a virtual knob 104 or other virtual control structures to have a specified degree of response to a given amount of movement of the virtual control structure. In this manner, a user may cause a specified amount or rate of movement of the virtual control structure to result in less incremental increase or decrease of the value 118 (i.e., reduce the sensitivity) or cause a specified amount or rate of movement of the virtual control structure to result in a greater incremental increase or decrease of the value 118 (i.e., increase the sensitivity).

Once the desired value for the operational parameter is reached, the user may accept this value, causing the new or adjusted operational parameter to be implemented on the monitor 14. In one embodiment, a user may tap (once, twice, or more times) the virtual control structure, such as virtual knob 104, to accept the adjusted value 118 and to begin operating using the adjusted value. In other embodiments, the user may touch or tap the displayed adjusted value 118 to accept this value or may touch a displayed button (e.g., an “Accept” button) displayed with the virtual control structure to allow a user to confirm or accept inputs made via the virtual control structure.

Upon receiving an indication that the adjustment process is completed, the monitor 14 may hide or minimize the display of the virtual control structure, e.g., the virtual knob 104 or virtual slider 110. That is, acceptance of the value adjusted using the virtual control structure may cause an operational parameter to utilize the adjusted value, as discussed above, as well as causing the virtual control structure used to adjust the value to be removed from or reduced in size on the touch screen 58. Thus, the touch screen 58 may be devoted to displaying physiological characteristics of a patient and/or monitor operational parameters without wasting space on the continued display of a control structure that is only needed when an operational parameter is being adjusted.

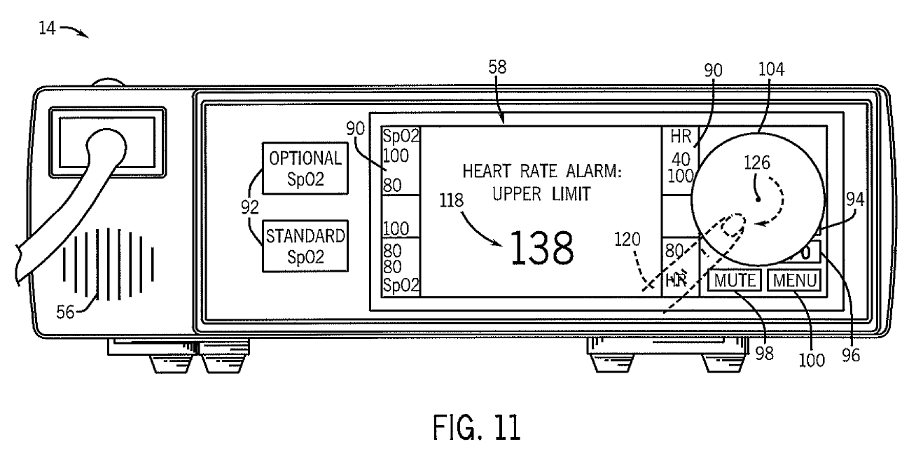

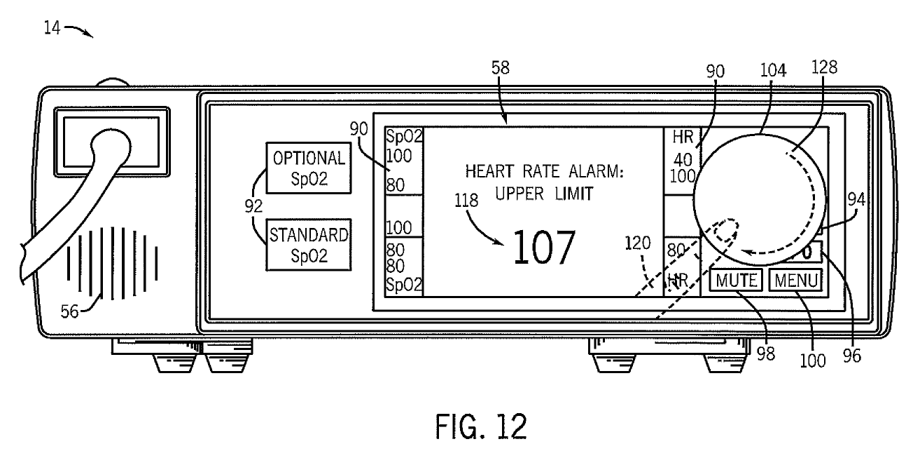

In one embodiment in which a virtual knob 104 is displayed as an implementation of a virtual control structure, touching different portions of the virtual knob 104 may cause different types or degrees of adjustment to the displayed value 118. Thus, in one embodiment, the radial distance between the user's fingertip and the center 126 of the virtual knob 104 may be proportional to the rate at which the value 118 is incremented when the virtual knob 104 is manipulated. For example, turning to FIG. 11, touching the virtual knob 104 near the center 126 when turning the virtual knob 104 may cause a rapid increase or decrease in the displayed value 118 thereby allowing the user to make a large adjustment to the value 118 with little effort and in a relatively quick manner. Conversely, turning to FIG. 12, touching the virtual knob 104 near the outer edge 128 when turning the virtual knob 104 may cause a slow increase or decrease in the displayed value 118, thereby allowing the user to make fine or small scale adjustment to the value 118.

As may be appreciated, in such an embodiment a user may move his finger radially on the virtual knob 104 during the adjustment process to alter the rate at which the displayed value 118 is being adjusted. That is, the user may initially rotate the virtual knob 104 near the center 126 to quickly get close to the desired value then, once the value is close, the user may slide his finger outward toward the edge 128 to fine tune the adjustment to the value 118. While the preceding discussion relates an implementation in which the rate of adjustment decreases as radial distance from the center 126 increases, other relationships may also be employed. In particular, the radial distance-rate of adjustment relationship may be reversed such that the closer to center 126 that a user touches the virtual knob 104, the slower the rate of adjustment.

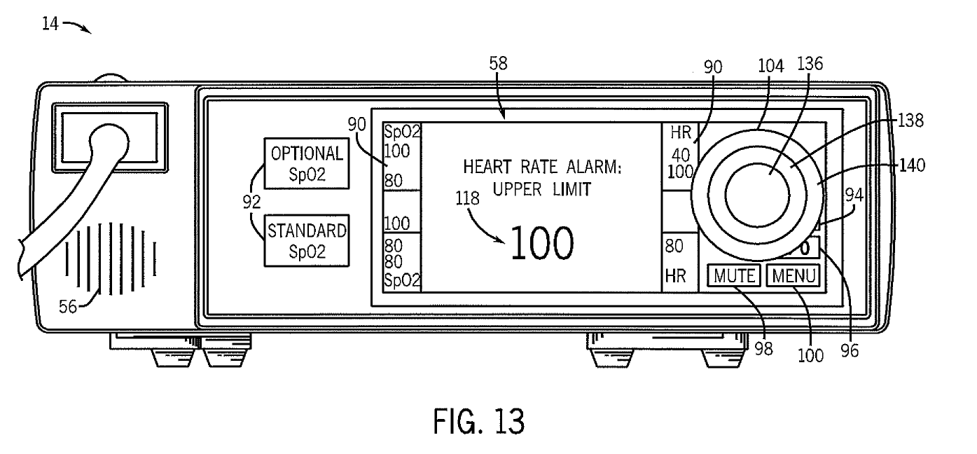

Further, turning to FIG. 13, in one embodiment the virtual knob 104 may be provided as a nested set of independently adjustable rings or dials, such as the depicted inner ring 136, middle ring 138, and outer ring 140, with each ring corresponding to a different place within the value 118, e.g., the hundredths place, the tenths place, the ones place, the tens place, the hundreds place, and so forth. In one embodiment where the value 118 to be adjusted may be a three digit number, the outer ring 140 may be rotated to adjust the value 118 at the ones place, i.e., 0-9, the middle ring 138 may be rotated to adjust the value 118 at the tens place, i.e., 0x-9x, and the inner ring 143 may be rotated to adjust the value 118 at the hundreds place, i.e., 0xx-9xx. Alternatively, this arrangement may be reversed such that the outer ring 140 may be rotated to adjust the value 118 at the hundreds place, the middle ring 138 may be rotated to adjust the value 118 at the tens place, and the inner ring 143 may be rotated to adjust the value 118 at the ones place. As will be appreciated, the number of rings displayed as part of the virtual knob 104 may depend on the parameter to be adjusted. That is, two rings may be displayed as part of the virtual knob 104 when a two digit value 118 is being adjusted, three rings may be displayed when a three digit value 118 is being adjusted, four rings may be displayed when a four digit value 118 is being adjusted, and so forth.

While the disclosure may be susceptible to various modifications and alternative forms, specific embodiments have been shown by way of example in the drawings and have been described in detail herein. However, it should be understood that the embodiments provided herein are not intended to be limited to the particular forms disclosed. Indeed, the disclosed embodiments may be applied to various types of medical devices and monitors, as well as to electronic device in general. Rather, the various embodiments may cover all modifications, equivalents, and alternatives falling within the spirit and scope of the disclosure as defined by the following appended claims.

What is claimed is:

1. A medical monitor, comprising:
a touch sensitive display; and
data processing circuitry capable of causing the touch sensitive display to display a virtual control structure, of receiving an input when the virtual control structure is manipulated by a continuous motion applied to the touch sensitive display, and of adjusting a selected parameter based upon the input.

2. The medical monitor of claim 1, wherein the data processing circuitry is capable of receiving a prompt via the touch sensitive display that causes the virtual control structure to be displayed.

3. The medical monitor of claim 1, wherein the virtual control structure comprises one of a virtual knob or a virtual slider.

4. The medical monitor of claim 1, wherein the data processing circuitry is capable of hiding or minimizing the virtual control structure after the selected parameter is adjusted.

5. The medical monitor of claim 1, wherein the data processing circuitry is capable of providing an audible indication when the virtual control structure is manipulated.

6. The medical monitor of claim 1, wherein the input is based upon the extent or distance of the continuous motion.

7. The medical monitor of claim 1, wherein the input is based upon the speed of the continuous motion.

8. A medical monitoring system, comprising:
a sensor suitable for acquiring data related to a physiological characteristic of a patient;
a monitor comprising:
a touch sensitive display;
data processing circuitry capable of causing a virtual knob to be to displayed on the touch sensitive display in response to a user prompt, of receiving an input based upon manipulation of the virtual knob, and of adjusting a parameter of the monitor in response to the input.

9. The medical monitoring system of claim 8, wherein the data processing circuitry is also capable of receiving the data acquired by the sensor, of generating a measure of the physiological characteristic based upon the data, and of displaying the measure.

10. The medical monitoring system of claim 8, wherein the data processing circuitry causes the virtual knob to appear to be depressed when the virtual knob is touched.

11. A medical monitor, comprising:
a touch sensitive display; and
data processing circuitry capable of causing the touch sensitive display to display a virtual knob and capable of adjusting a parameter of the medical monitor in response to manipulation of the virtual knob.

12. The medical monitor of claim 11, wherein the data processing circuitry is capable of hiding or minimizing the virtual knob when the parameter is not being adjusted.

13. The medical monitor of claim 11, wherein the data processing circuitry is capable of causing the virtual knob to be displayed on a right side or a left side of the touch sensitive display based upon a user identity or preference.

14. The medical monitor of claim 11, wherein the data processing circuitry is capable of audibly indicating when the virtual knob is manipulated.

15. The medical monitor of claim 11, wherein the data processing circuitry is capable of altering the appearance of the virtual knob when the virtual knob is touched.

16. The medical monitor of claim 11, wherein the data processing circuitry is capable of altering the position of the virtual knob when the virtual knob is touched.

17. The medical monitor of claim 11, wherein the data processing circuitry adjusts the parameter in response to an extent or degree by which the virtual knob is rotated.

18. The medical monitor of claim 11, wherein the data processing circuitry adjusts the parameter in response to a rate at which the virtual knob is rotated.

19. The medical monitor of claim 11, wherein the rate at which the parameter is adjusted is based upon a distance between a center of the virtual knob and a contact point where the virtual knob is touched while being manipulated.

20. The medical monitor of claim 11, wherein the virtual knob comprises two or more regions that can be independently manipulated.
